(19) United States
(12) Patent Application Publication
(10) Pub. No.: US 2026/0016104 A1
(43) Pub. Date: Jan. 15, 2026

(54) SEMI-ALL-PURPOSE FLANGE

(71) Applicant: Matthew Leitner, Crosby, TX (US)

(72) Inventor: Matthew Leitner, Crosby, TX (US)

(21) Appl. No.: 19/267,080

(22) Filed: Jul. 11, 2025

Related U.S. Application Data
(60) Provisional application No. 63/669,975, filed on Jul. 11, 2024.

(51) Int. Cl. F16L 23/00

(52) U.S. Cl. CPC F16L 23/00

(57) ABSTRACT

Apparatus and associated methods relate to a flange assembly including a semi-all-purpose flange extending along a longitudinal axis, the semi all-all purpose-flange. The semi-all-purpose flange includes a neck positioned proximally along the longitudinal axis and a head positioned distally from the neck along the longitudinal axis. A cavity extends into a portion of the longitudinal axis; the cavity penetrates a portion of the axial depth of the flange and has a conical interior cross-section centered on the longitudinal axis. The semi-all-purpose flange includes a solid internal grain structure geometry configured such that material surrounding the cavity may be selectively removed to form multiple flange types while maintaining structural continuity between the neck and the head.

### CROSS-REFERENCE TO RELATED APPLICATIONS

This application also claims the benefit of U.S. Provisional Application Ser. No. 63/669,975, titled “SEMI-ALL-PURPOSE FLANGE,” filed by Matthew Leitner on Jul. 11, 2024.

This application incorporates the entire contents of the foregoing applications herein by reference.

### TECHNICAL FIELD

Various embodiments relate generally to flanges.

### BACKGROUND

Flanges may be important components in piping systems, serving to connect pipes, valves, pumps, and other equipment. They may provide easy access for inspection, cleaning, and modification, ensuring a secure and leak-proof connection. In the oil and gas industry, flanges may be important for maintaining the integrity of pipelines that transport hydrocarbons under high pressure and harsh conditions. They may facilitate the assembly and disassembly of pipeline sections, allowing for maintenance and repairs without significant downtime. Various types of flanges, such as weld neck, slip-on, and blind, may be used to meet different operational needs.

### SUMMARY

Apparatus and associated methods relate to a flange assembly including a semi-all-purpose flange extending along a longitudinal axis, the semi all-all purpose-flange. The semi-all-purpose flange includes a neck positioned proximally along the longitudinal axis and a head positioned distally from the neck along the longitudinal axis. A cavity extends into a portion of the longitudinal axis; the cavity penetrates a portion of the axial depth of the flange and has a conical interior cross-section centered on the longitudinal axis. The semi-all-purpose flange includes a solid internal grain structure geometry configured such that material surrounding the cavity may be selectively removed to form multiple flange types while maintaining structural continuity between the neck and the head.

Various embodiments may achieve one or more advantages. Various embodiments may advantageously include cavities that terminate in a tapered end portion located within the distal head, the end portion including either a conical or curved interior surface geometry centered on the longitudinal axis. Some embodiments may enhance structural integrity and mechanical performance while accommodating post-manufacture customization. Other embodiments may improve manufacturing efficiency by enabling a single flange structure to serve multiple functional roles, thereby reducing part inventory and streamlining production workflows. Still other embodiments may maintain continuous load paths through the flange, promoting durability under varying stress conditions.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary semi-all-purpose flange employed in an illustrative use-case scenario.

FIG. 2 depicts an exemplary semi-all-purpose flange manufactured into a slip-on flange of a predetermined dimension.

FIG. 3 depicts an exemplary semi-all-purpose flange manufactured into a true lap joint.

FIG. 4 depicts an exemplary semi all-purpose flange.

FIG. 5 depicts an exemplary semi-all-purpose flange manufactured into a slip-on flange of a predetermined dimension.

FIG. 6 depicts an exemplary semi-all-purpose flange manufactured into a slip-on flange of a predetermined dimension.

FIG. 7 depicts an exemplary circular notched semi-all-purpose flange prior to manufacturing.

FIG. 8 depicts an exemplary cone notched semi-all-purpose flange during manufacturing.

FIG. 9 depicts an exemplary semi-all-purpose flange schematic.

Like reference symbols in the various drawings indicate like elements.

### DETAILED DESCRIPTION OF ILLUSTRATIVE EMBODIMENTS

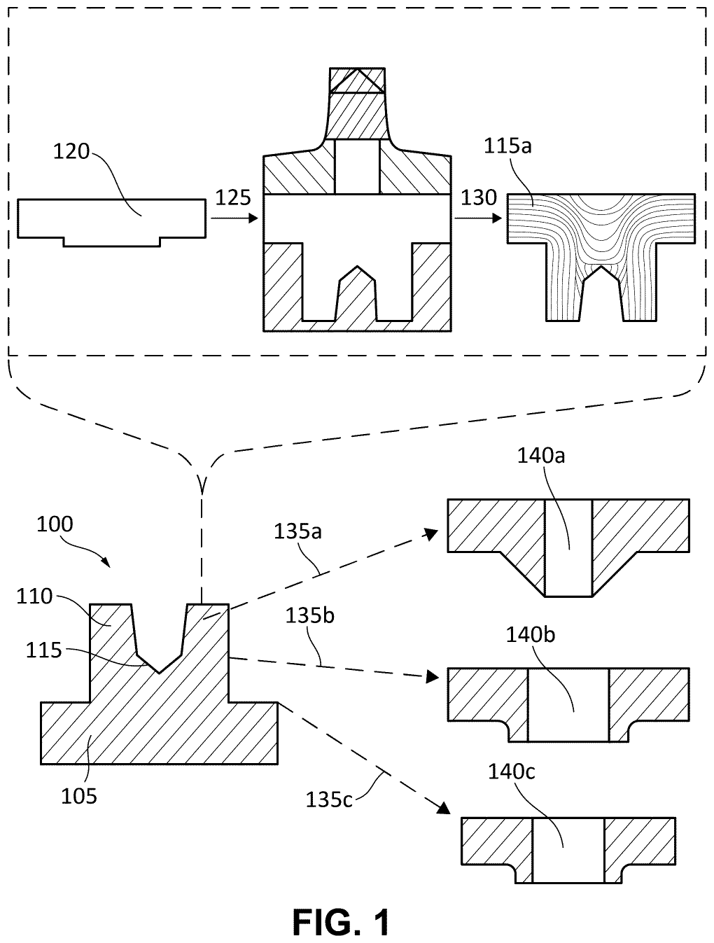

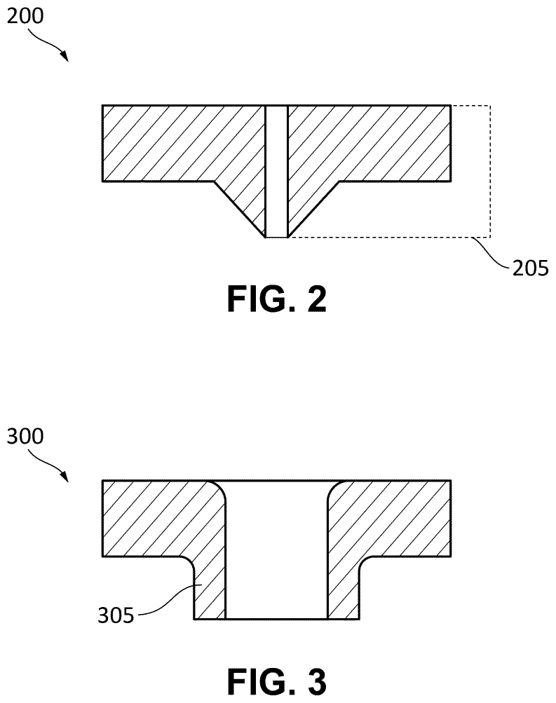

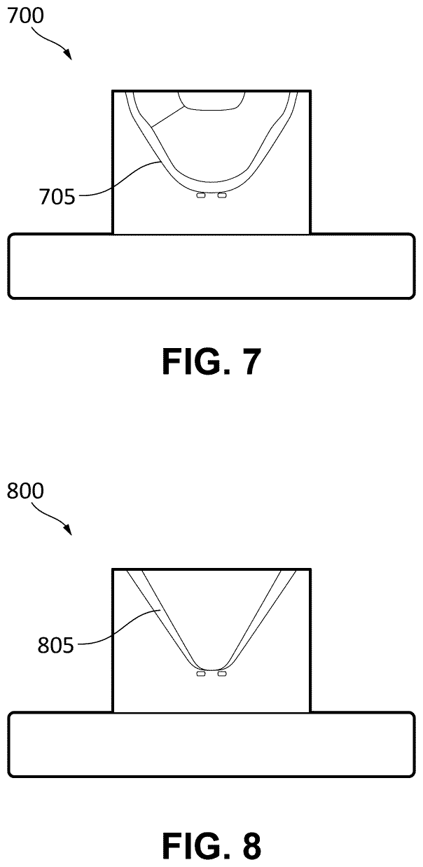

To aid understanding, this document is organized as follows. First, to help introduce discussion of various embodiments, a illustrative use-case scenario is introduced with reference to FIG. 1. Second, that introduction leads into a description with reference to FIGS. 2-6 of some exemplary embodiments of. Third, with reference to FIGS. 7-9, depict some embodiments and schematic of an exemplary semi all-purpose flange.

FIG. 1 depicts an exemplary semi-all-purpose flange 100 employed in an illustrative use-case scenario. The semi-all-purpose flange 100 includes a head 105. The semi-all-purpose flange 115 includes a neck 110. The semi-all-purpose flange 100 includes a premanufactured aperture with a coned interior 115.

The semi-all-purpose flange 100 may, for example, be manufactured from a premanufactured flange 120. The premanufactured flange may, for example, include a head. The premanufactured flange may, for example, include a neck.

The premanufactured flange 120 may, for example, be inserted into a die 125. The die may, for example, press onto the premanufacture flange 120 to create a coned aperture extending into and centered on the neck but not going all the way through the flange. The coned aperture may, for example, only extend partially into the neck leaving the head intact.

The die 125 may, for example, create the semi-all-purpose flange 100. The semi-all-purpose flange may, for example, include a solid grain structure 115a, that may, for example, allow manufacturers to create high quality flanges later. The semi-all-purpose flange may, for example, be manufactured in one country, and be shipped in mass to another country. The semi-all-purpose flange may, for example, be manufactured in the second country. The semi-all purpose flange may, for example, be much more cost effective to manufacture a flange from an existing semi all-purpose flange. Companies may, for example, have less inventory requirements by stocking a semi all-purpose flange.

The semi-all-purpose flange 100 may, for example, be manufactured in a manufacturing process 135a. The manufacturing process 135a may, for example, create a flange with predetermined dimensions 140a.

The semi-all-purpose flange 100 may, for example, be manufactured in a manufacturing process 135b. The manufacturing process 135a may, for example, create a flange with predetermined dimensions 140b.

The semi-all-purpose flange 100 may, for example, be manufactured in a manufacturing process 135b. The manufacturing process 135a may, for example, create a flange with predetermined dimensions 140c.

FIG. 2 depicts an exemplary semi-all-purpose flange manufactured into a slip-on flange 200 of a predetermined dimension. The slip-on flange 200 includes a tapered neck 205. This flange design incorporates a semi-all-purpose flange that may, for example, allow for easier modifications and fitment for various piping requirements. The area of the half hole in the semi-all-purpose flange may, for example, be deep enough to accommodate multiple iterations of machining, specifically aimed at ensuring the versatility required in multi-stage industrial applications. The semi-all-purpose flange may, for example, feature a critical inner diameter (ID) that is smaller at the top, designed to support complex beveling processes necessary for creating high-precision interfaces.

FIG. 3 depicts an exemplary semi-all-purpose flange 300 manufactured into a true lap joint 305. The true lap joint 300 configuration may, for example, be achieved by adapting the semi-all-purpose flange to provide a stronger, more durable connection ideal for high-stress applications. The semi-all-purpose flange used in this true lap joint may, for example, feature enhanced mechanical properties to withstand the dynamic loads and environmental conditions typically encountered in industrial settings. The design of the semi-all-purpose flange may, for example, incorporate precision engineering to ensure perfect alignment and seal, which is important in maintaining system integrity. This adaptation of the semi-all-purpose flange may, for example, optimize both cost and performance, making it an attractive option for projects requiring reliable long-term connections.

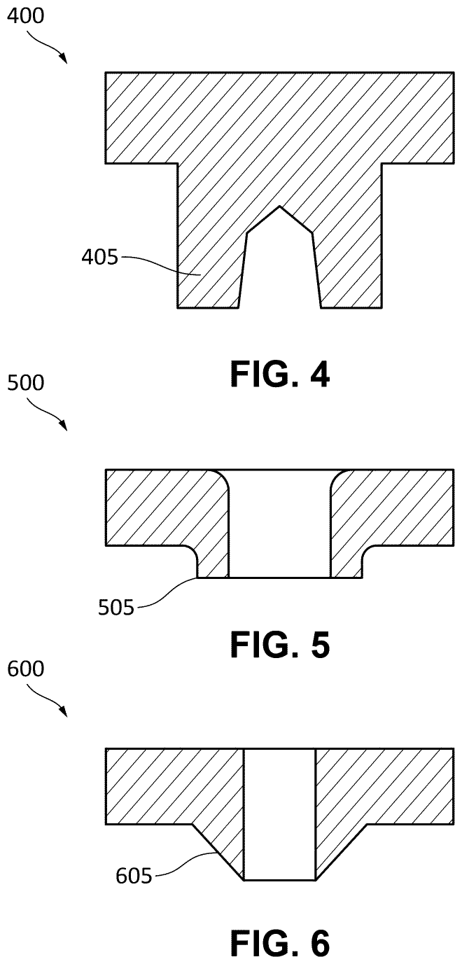

FIG. 4 depicts an exemplary semi-all-purpose flange 400 designed to cover a diverse range of piping specifications and standards including B16.5, API, Awwa, En, DN, ISO, and Gost. The semi-all purpose flange includes conical portion 405. The semi-all-purpose flange may, for example, be designed to include special outer diameters, angled outer diameters, and specific hub diameters that enable reductions in exposure to pounds, which significantly drives down inventory costs.

In some embodiments, the semi-all-purpose flange may, for example, be versatile enough to accommodate three different sizes and six styles as specified, and for some sizes even more scalable, illustrating its adaptability to various piping systems and standards. Example configurations include forgings that can adapt to B16.5 3″ 600 lb, 2″ 1500 lb, and 1½″ 2500 lb, API 6A 2 1/16 15000 6BX WN, 2 9/16 2000 6BX WN, EN 1092, DN65 PN100, DN80 PN40, orDN50 PN320, DN40 PN400, essentially all types in En1092, in some cases it will even adapt to SAE code 61 or code 62 flanges, which are crucial for applications requiring precise pressure specifications. The ability to conform to multiple standards such as AWWA, ISO, JIS-80A, GOST, BS, API, MSS SP-44, SAE, and DIN EN 1092 showcases the flange's capability to serve a broad spectrum of industrial needs.

In some embodiments, the semi-all-purpose flange may, for example, leverage flashless forging to cover any necessary size with a proprietary combination of diameters, enhancing the flange's utility in high-demand sectors. This process not only ensures the production of high-quality components but also supports efficient manufacturing practices by minimizing waste and optimizing the use of materials. The strategic design and manufacturing approach embodied in the semi-all-purpose flange may serve as a key asset in reducing operational and inventory costs across diverse industries.

FIG. 5 depicts an exemplary semi-all-purpose flange 500 manufactured into a slip-on flange of a predetermined dimension. The semi-flange when manufactured may, for example, include an aperture 505 that extends from the neck and through the body. The adaptability of the semi-all-purpose flange may, for example, offer significant cost savings by reducing the need for specialized flanges for each application.

FIG. 6 depicts an exemplary semi-all-purpose flange 600 manufactured into a slip-on flange of a predetermined dimension. When manufactured the aperture as depicted may, for example, extend through the neck and through the body. The neck of the semi-all-purpose flange may, for example, include a taper 605.

FIG. 7 depicts an exemplary circular notched semi-all-purpose flange 700 prior to manufacturing. The semi-all purpose flange 700 includes a curved cavity 705. The cavity may, for example, be manufactured into a flange extending from the cavity through the body of the flange.

FIG. 8 depicts an exemplary cone notched semi-all-purpose flange 800 during manufacturing. The semi-all purpose flange 800 includes a curved cavity 805. The cavity may, for example, be manufactured into a flange extending from the cavity through the body of the flange.

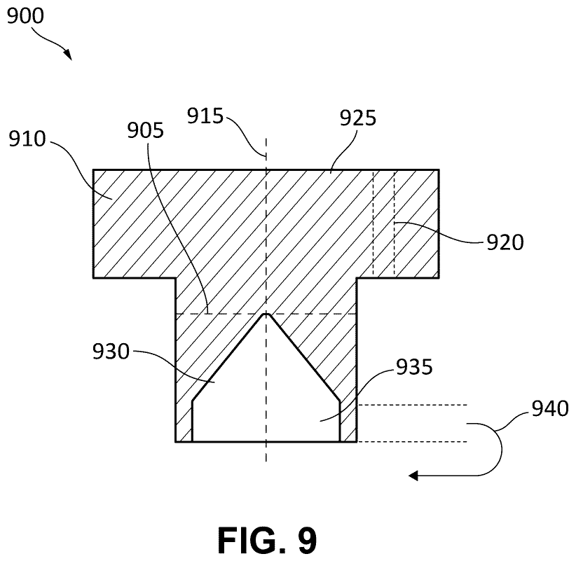

FIG. 9 depicts an exemplary semi-all-purpose flange schematic 900. The flange schematic 900 includes a central body portion 905, which forms the core structure of the flange. Extending laterally from the body portion 905 is a flange head 910, which provides structural support and surface area for interface with adjoining components. A longitudinal axis 915 passes through the center of the body portion 905 and flange head 910, serving as the axis of symmetry for rotational operations. Surrounding the flange head 910 is a body height region 920, which defines the vertical extent of the flange and contributes to its load-bearing capacity. The outermost edge of the body height region 920 defines the perimeter boundary 925, which determines the flange's overall footprint when viewed from the top. Beneath the central body portion 905 is a taper 930, which facilitates gradual reduction in cross-sectional area and enhances stress distribution. Adjacent to the taper 930 is a cavity 935, which is formed via a die to achieve a controlled, uniform internal shape. When the cavity 935 is revolved about the longitudinal axis 915, it produces a rotationally symmetric profile 940 that maintains consistent geometry for reliable performance under various configurations.

In some embodiments, a semi-all-purpose flange may be initially manufactured with a standardized external geometry and a partially formed internal cavity, enabling it to later be finished into a full flange type as needed. This semi-finished state allows the flange to remain in a general-purpose form until a specific application or standard is required-such as weld neck, slip-on, lap joint, or blind flanges. By incorporating features like a tapered cavity and consistent neck diameter, the semi-all-purpose flange provides a reliable base for machining operations that can customize the bore, face, or bolt pattern.

One key advantage of this design is inventory optimization: manufacturers and distributors need to stock only one type of semi-all-purpose flange, which can be stored in bulk and customized just-in-time to meet end-user requirements. This significantly reduces the need to maintain a large inventory of different flange types and sizes. Furthermore, this approach supports lean manufacturing practices, lowers warehouse costs, and enhances responsiveness to changing project specifications or industry standards. The ability to convert the semi-all-purpose flange into a fully specified flange near the point of use also minimizes lead times and promotes global supply chain efficiency.

Some embodiments may, for example, be adapted to both high hub and angled or straight hub configurations, catering to diverse application needs. The utilization of a flashless die is planned to ensure clean and precise grain flow in the metal, enhancing the final product's structural integrity. An S4 Macro Etch Test is also scheduled at this stage to rigorously assess the quality of the metal grain flow, ensuring it meets high-quality standards. This foundational preparation is critical, as it sets the stage for producing a flange with superior mechanical properties. Additionally, the pre-die phase involves detailed preparation of the raw material, which includes cutting, shaping, and pre-heating the metal to precise specifications before it is positioned within the die setup. This meticulous attention to the material and design specifics is essential for ensuring that the production process yields a reliable and efficient product.

Some embodiments, manufacturing process may, for example, begins with the integration of a quick die connect system, which facilitates rapid and efficient forging cycles. A raw shoot setup is employed to handle the initial forging stages, where precise material placement is crucial. The assist die press is instrumental at this point, applying just the right amount of pressure to ensure a tight seal without any material flap. This phase of the manufacturing process is designed to maintain high consistency across batches, which is vital for quality control. The controlled forging environment helps optimize the grain flow, enhancing the mechanical strengths of the flange.

As manufacturing progresses, further precision in the forging process is achieved. The mid-stage of production involves detailed monitoring and adjustment of the forging parameters to ensure optimal grain flow and structural integrity. Technicians oversee the process, making real-time adjustments to the equipment to maintain strict quality standards. This stage is critical for ensuring that the mechanical properties of the flange are developed to their full potential. The ongoing quality assurance measures during this phase help prevent defects and ensure that each flange meets the specified design criteria. The result is a series of forgings that consistently meet high standards of quality and reliability.

Some embodiments may, for example, include an exemplary semi-all-purpose flange as it nears the completion of the manufacturing process. At this stage, the focus shifts to finalizing the mechanical properties and surface finish of the flange. Advanced machining techniques are employed to refine the flange's dimensions and ensure precise fitment. Final inspections are conducted to verify that the flange meets all operational and safety standards. This last phase is crucial for confirming the flange's capability to perform reliably in its intended environment. The completion of these steps marks the readiness of the flange for shipping to clients and installation in various industrial systems.

In some embodiments, post-manufacturing, the semi-all-purpose flange undergoes a series of rigorous tests to confirm its durability and performance under simulated operational conditions. These tests are designed to challenge the flange's mechanical and thermal resilience, ensuring it can withstand the rigors of actual industrial use. Feedback from these tests is used to make any necessary adjustments in future production cycles, enhancing the product's design and functionality. This continuous improvement process is essential for maintaining the high standards expected of such critical components in industrial applications. The feedback and adjustments help ensure that the semi-all-purpose flange remains a reliable and essential component in various industrial settings.

In some embodiments, the semi-all-purpose flange is designed to significantly reduce the inventory of pre-manufactured flanges required by companies. By providing a versatile base that can be customized into various specific configurations, the flange eliminates the need for stocking multiple types of specialized flanges. This not only simplifies inventory management but also reduces storage space and associated costs. Furthermore, the adaptable nature of the semi-all-purpose flange means that companies can respond more swiftly to changes in project requirements or market demands. As it can be adapted on-site to meet specific needs, it reduces lead times and enhances operational efficiency. The reduction in the variety of flanges kept in inventory also simplifies the training required for staff, as they need to understand and handle fewer types of flanges.

In some embodiments, the semi-all-purpose flange may also be manufactured in one country and then shipped to another country for final customization and installation. This manufacturing strategy allows for the use of specialized manufacturing facilities that can produce the semi-all-purpose flanges at a lower cost due to economies of scale or technological advantages. Once the basic form of the flange is created, it can be exported to various markets where it can be finished according to local specifications and requirements. This approach not only reduces production costs but also minimizes the time and expense involved in setting up multiple manufacturing units across different regions. Moreover, this method allows companies to maintain a high standard of quality control at the manufacturing stage while offering flexibility in the final product customization at the destination. Such a strategy is particularly advantageous in industries like oil and gas, where equipment specifications can vary widely from one project to another.

Some embodiments of the semi-all-purpose flange cater to a range of industrial applications, enhancing its utility across sectors. For instance, one embodiment might be designed for high-pressure environments such as deep-sea oil drilling, while another could be tailored for use in the chemical processing industry, which may require flanges made from specialized corrosion-resistant materials. Additionally, variations of the semi-all-purpose flange can be made to withstand extreme temperatures or abrasive materials. This versatility ensures that the semi-all-purpose flange can be used in a wide array of settings, from conventional water supply systems to advanced aerospace applications. Each embodiment is developed with particular operational conditions in mind, providing a tailored solution that ensures safety, reliability, and cost-effectiveness.

In some embodiments, the ability to customize the semi-all-purpose flange in the destination country before its final use is particularly beneficial. This capability allows for last-minute adjustments based on precise field measurements or unforeseen site conditions, which might not be accurately predicted during the initial stages of a project. Such flexibility can lead to significant savings in time and costs, as there is no need to return the flange to the manufacturing site for reworking. Additionally, local customization helps in adhering to specific local standards and regulations, which may vary significantly from one region to another. The presence of local customization facilities also supports local economies by providing jobs and fostering the development of technical expertise.

In some embodiments, the semi-all-purpose flange facilitates a more sustainable manufacturing and supply chain model. By reducing the number of flanges that need to be produced and held in inventory, it contributes to a decrease in the manufacturing carbon footprint. Less waste is produced since fewer flanges are discarded due to obsolescence or improper specifications. Additionally, shipping unfinished flanges and completing them closer to where they are needed reduces transportation emissions associated with distributing multiple different types of flanges to various locations. This model not only supports global efforts to reduce environmental impact but also aligns with the growing corporate commitment to sustainable practices in industrial production and logistics.

In some embodiments, the semi-all-purpose flange may, for example, be designed with a flexible interface. This adaptability allows for attachment via bolted, clamped, or welded joints. Such versatility reduces the need for multiple unique flange models, simplifying inventory management. The flange may, for example, feature standardized external dimensions with customizable internal modifications. It may, for example, include pre-drilled pilot holes that can be expanded based on specific requirements. Modular design elements streamline manufacturing and assembly processes, enhancing efficiency.

In some embodiments, the semi-all-purpose flange may, for example, utilize advanced materials for enhanced durability. These may include composites or high-performance alloys capable of enduring extreme conditions. Optimal performance is ensured by materials tailored to typical applications and environmental demands. Surface treatments enhance corrosion resistance and mechanical properties. Precision machining and computer-aided manufacturing techniques ensure each flange meets high quality standards.

In some embodiments, the semi-all-purpose flange may, for example, be designed for easy inspection and maintenance. External indicators help assess the flange's condition without disassembly. Features like wear markers or integrated sensors enable predictive maintenance. Quick-release mechanisms facilitate rapid disassembly, speeding up repairs and adjustments. This maintenance-friendly design improves system reliability by reducing downtime.

In some embodiments, the semi-all-purpose flange may, for example, incorporate energy-efficient manufacturing processes. Recycled materials align with sustainable manufacturing goals. Production facilities may use renewable energy sources to reduce the carbon footprint. Near-net-shape forging techniques minimize excess material use. Designed for end-of-life recyclability, components can be easily separated and reused.

In some embodiments, the semi-all-purpose flange may, for example, feature a variety of surface finishes. Finishes may include non-reflective coatings for low visibility applications. Decorative coatings enhance aesthetic value without compromising functionality. Coatings provide additional protection against environmental factors. Easy re-coating extends usability and maintains appearance. Customizable finish options enhance marketability and meet customer preferences.

In some embodiments, a flange is manufactured without a neck, resulting in a residual piece of material with a conical interior diameter (ID). This residual material may be repurposed for fabricating pressure connections, spacers, or other thin components. Utilizing this leftover material may reduce costs associated with raw material procurement and transportation, thereby providing a cost-effective alternative to traditional material sourcing methods.

In some embodiments, the strategic reuse of flange material remnants may be viewed as a cost-saving measure, effectively optimizing resource utilization and minimizing waste. This approach may necessitate considerations regarding inventory management and tax implications, depending on regulatory practices related to inventory valuation and taxation.

In some embodiments, the design and manufacturing processes of the flange may be subject to revisions to enhance versatility or scalability to accommodate additional standards or sizes not initially anticipated. Such adaptability allows for iterative modifications based on emerging findings or requirements, thereby facilitating continuous improvement and expansion of the flange's application potential within diverse industrial contexts.

Some embodiments may, for example, relate to a semi-all-purpose flange featuring an aperture that partially extends from the neck into the head, protruding at least 50% into the flange. This configuration preserves the core of the flange's head, allowing for subsequent customization to meet specific requirements. In an illustrative example, the semi-all-purpose flange may include an aperture that protrudes through half of the flange. Additionally, 35-40% of the flange may need to be manufactured at the neck.

The cover may, for example, accommodate 3 sizes or more (e.g., B-16.36, 300 lb & down, B16.5 2-900 # and smaller, EN1092 DN40 PN100 & down etc) and at least 6 styles (e.g., B16.5 (in), Asme B16.36, API (mm), AwwA (in), En (mm), DN (mm), Iso (in), gost (mm), JIS (mm) BS: 10, 4504 (mm) and MSS SP 44

Some embodiments may undergo a two-stage manufacturing process—initial die pressing followed by precision machining at a secondary location. This process ensures high precision and durability. Furthermore, a metallurgical analysis may be conducted on the flange to create customized flanges based on specific engineering specifications, ensuring adaptability and reliability across diverse industrial applications.

Although various embodiments have been described with reference to the figures, other embodiments are possible.

Although an exemplary system has been described with reference to FIG. 1-9, other implementations may be deployed in other industrial, scientific, medical, commercial, and/or residential applications.

In industrial applications, including the oil and gas industry, the semi-all-purpose flange may, for example, be utilized in heavy machinery, manufacturing equipment, and pipeline systems. The semi-all-purpose flange may ensure robust connections that withstand high pressures and temperatures, which is crucial for transporting hydrocarbons. Additionally, the semi-all-purpose flange may facilitate maintenance and assembly in complex industrial systems, providing versatility and reliability. In refineries and both onshore and offshore drilling operations, the semi-all-purpose flange may withstand harsh environmental conditions, ensuring the integrity of high-temperature and high-pressure systems.

In scientific applications, the semi-all-purpose flange may, for example, be employed in laboratory equipment and experimental setups. The semi-all-purpose flange may provide precise and secure connections for various instruments, ensuring accuracy in experimental results. Furthermore, the semi-all-purpose flange may allow for easy modification and adaptation to meet specific experimental requirements, enhancing research capabilities.

In medical applications, the semi-all-purpose flange may, for example, be used in medical devices and hospital equipment. The semi-all-purpose flange may ensure reliable and hygienic connections in critical medical environments. The semi-all-purpose flange may support the customization of medical devices to meet specific patient needs, improving the functionality and safety of medical equipment.

In commercial applications, the semi-all-purpose flange may, for example, be implemented in HVAC systems, plumbing, and building infrastructure. The semi-all-purpose flange may provide durable and secure connections, ensuring the efficient operation of commercial systems. Additionally, the semi-all-purpose flange may allow for easy installation and maintenance, reducing operational costs and downtime.

In residential applications, the semi-all-purpose flange may, for example, be used in home plumbing systems, heating systems, and appliance connections. The semi-all-purpose flange may ensure safe and reliable connections, contributing to the overall safety and functionality of residential infrastructure. The semi-all-purpose flange may be designed for easy installation and maintenance, making it a practical choice for homeowners.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A semi-all-purpose flange extending along a longitudinal axis, the semi-all purpose flange comprising:
a neck positioned proximally along the longitudinal axis;
a head positioned distally from the neck along the longitudinal axis;
a cavity extending into a portion of the neck along the longitudinal axis, the cavity penetrating less than the full axial depth of the flange and having a conical interior cross-section centered on the longitudinal axis; and,
a solid internal grain structure configured such that material surrounding the cavity may be selectively removed to form multiple flange types while maintaining structural continuity between the neck and the head.

2. The semi-all-purpose flange of claim 1, further comprising a tapered end portion of the cavity located within the neck.

3. The semi-all-purpose flange of claim 1, wherein the cavity terminates in an end portion, the end portion comprising a tapered surface geometry centered on the longitudinal axis.

4. The semi-all-purpose flange of claim 1, wherein the cavity terminates in an end portion, the end portion comprising a curved surface geometry centered on the longitudinal axis.

5. The semi-all-purpose flange of claim 1, wherein the cavity extends from the proximal end of the neck to a depth of at least 25 percent of the total axial length of the flange measured along the longitudinal axis.

6. The semi-all-purpose flange of claim 1, wherein the cavity extends from the proximal end of the neck to a depth of at least 40 percent of the total axial length of the flange measured along the longitudinal axis.

7. The semi-all-purpose flange of claim 1, wherein the neck comprises a tapered outer profile extending proximally from the head.

8. The semi-all-purpose flange of claim 1, wherein the cavity is rotationally symmetric about the longitudinal axis and formed using a die press.

9. The semi-all-purpose flange of claim 1, wherein the semi-all-purpose flange is configured to be manufactured into a slip-on flange.

10. The semi-all-purpose flange of claim 1, wherein the semi-all-purpose flange is configured to be manufactured into a weld neck flange.

11. The semi-all-purpose flange of claim 1, wherein the semi-all-purpose flange is configured to be manufactured into a lap joint flange.

12. The semi-all-purpose flange of claim 1, wherein the semi-all-purpose flange is configured to be manufactured into a blind flange.

13. The semi-all-purpose flange of claim 1, wherein the flange is stored in an unfinished state and selected for final machining based on application-specific requirements.

14. The semi-all-purpose flange of claim 1, wherein the flange is forged using a flashless die process to ensure continuous grain flow between the neck and the head.

15. The semi-all-purpose flange of claim 1, wherein the cavity is dimensioned to terminate before reaching the head and the head remains a solid mass during initial manufacturing.

16. The semi-all-purpose flange of claim 1, further comprising a flange thickness from the distal face to the cavity base configured to sealing surfaces.

17. The semi-all-purpose flange of claim 1, further comprising a flange thickness from the distal face to the cavity base configured to ring-type joint features.

18. The semi-all-purpose flange of claim 1, wherein the flange geometry is defined by a revolution of the cavity and outer contours about the longitudinal axis.

19. The semi-all-purpose flange of claim 1, wherein the semi-all-purpose flange is configured to be initially formed in a first geographic location and subsequently machined into a final flange configuration in a second geographic location.

20. The semi-all-purpose flange of claim 1, further comprising a two-stage manufacturing process, the first stage comprising die forging of the cavity and grain structure, and the second stage comprising selective material removal to form a fully specified flange type based on a selected application.
